(19) United States
(12) Patent Application Publication
(10) Pub. No.: US 2025/0349036 A1
(43) Pub. Date: Nov. 13, 2025

(54) NOISE MODEL BASED COMPRESSION

(71) Applicant: Mobileye Vision Technologies Ltd., Jerusalem (IL)

(72) Inventors: Amit Weizner, Haifa (IL); Gabriel Bowers, Boulogne-Billancourt (FR)

(73) Assignee: Mobileye Vision Technologies Ltd., Jerusalem (IL)

(21) Appl. No.: 19/197,260

(22) Filed: May 2, 2025

Related U.S. Application Data
(60) Provisional application No. 63/643,535, filed on May 7, 2024.
(60) Provisional application No. 63/677,002, filed on Jul. 30, 2024.

(51) Int. Cl. G06T 9/00; G06T 3/40; G06T 7/00

(52) U.S. Cl. CPC G06T 9/00; G06T 3/40; G06T 7/0002; G06T 2207/30168; G06T 2207/30252

(57) ABSTRACT

Techniques are disclosed for performing residual image compression techniques used in conjunction with image and/or video predictors. The techniques utilize a compression scheme that implements a noise model to estimate noise values of pixels in an originally acquired image. These noise value estimates are then used to perform residual image compression more efficiently by performing a non-uniform reduction in resolution of the residual image. The resolution reduction includes dropping least significant bits (LSBs) used to encode each pixel on a pixel-by-pixel basis based upon the noise value estimates of the originally acquired image.

### CROSS-REFERENCE TO RELATED APPLICATIONS

This application claims priority to provisional application No. 63,643,535, filed on May 7, 2024, and to provisional application No. 63,677,002, filed on Jul. 30, 2024, the contents of each of which are incorporated herein by reference in their entireties.

### TECHNICAL FIELD

This disclosure generally relates to compression techniques used in conjunction with image and/or video acquisition and, more particularly, to the implementation of a compression scheme that utilizes a noise model to perform residual image compression more efficiently.

### BACKGROUND

For many applications, a large amount of images may be acquired and then stored at a separate location, such as networked or cloud storage. As part of this process, it is desirable to use image-based compression techniques to reduce the bandwidth and the amount of space needed for the storage of acquired images. To this end, many image/video codecs rely on image prediction mechanisms and residual image compression. As part of such compression techniques, a residual image is typically generated that represents a difference between a “real” (i.e. original) acquired image and the prediction of that image. Thus, the residual image may represent a compressed version of the acquired image, with the original image being restored by combining the prediction with its corresponding residual. The residual image may be further compressed prior to transmission and/or storage, although current residual image compression techniques suffer from various drawbacks, particularly with respect to compression efficiency.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1 illustrates an example vehicle in accordance with one or more aspects of the present disclosure.

FIG. 2 illustrates various example electronic components of a safety system of a vehicle, in accordance with one or more aspects of the present disclosure;

FIGS. 3A-3B illustrate the use of predictors to generate a predicted image from an acquired image;

FIG. 4 illustrates an example of residual image compression implementing a noise model, in accordance with one or more aspects of the present disclosure; and

FIG. 5 illustrates an example process flow, in accordance with one or more aspects of the disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

### I. Autonomous Vehicle Architecture and Operation

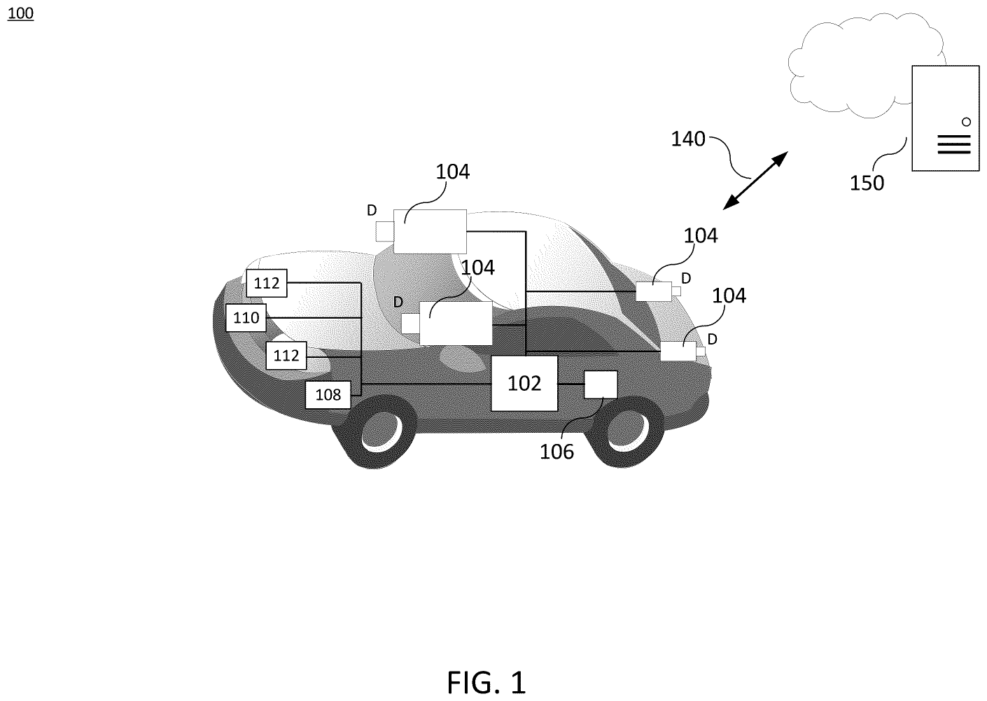

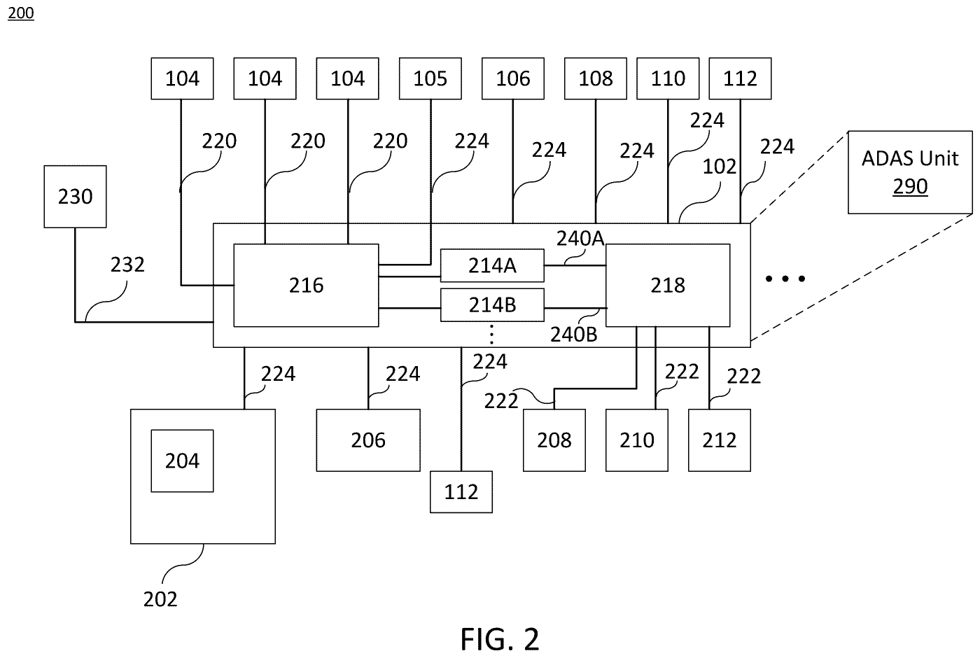

FIG. 1 shows an example vehicle 100 including a safety system 200 (see also FIG. 2) in accordance with various aspects of the present disclosure. The vehicle 100 and the safety system 200 are exemplary in nature, and may thus be simplified for explanatory purposes. Locations of elements and relational distances (as discussed herein, the Figures are not to scale) are provided by way of example and not limitation. The safety system 200 may include various components depending on the requirements of a particular implementation and/or application, and may facilitate the navigation and/or control of the vehicle 100. Thus, the safety system 200, or any subset of components of the safety system 200, may comprise a navigation system for use in navigating a host vehicle in which it is implemented in any suitable manner, including those described in further detail herein. The vehicle 100 may be an autonomous vehicle (AV), which may include any level of automation (e.g. levels 0-5), which includes no automation or full automation (level 5). The vehicle 100 may implement the safety system 200 as part of any suitable type of autonomous or driver assistance control system, including AV and/or advanced driver-assistance system (ADAS), for instance. The safety system 200 may include one or more components that are integrated as part of the vehicle 100 during manufacture, part of an add-on or aftermarket device, or combinations of these. Thus, the various components of the safety system 200 as shown in FIG. 2 may be integrated as part of the vehicle's systems and/or part of an aftermarket system that is installed in the vehicle 100.

The one or more processors 102 may be integrated with or separate from an electronic control unit (ECU) of the vehicle 100 or an engine control unit of the vehicle 100, which may be considered herein as a specialized type of an electronic control unit. The safety system 200 may generate data to control or assist to control the ECU and/or other components of the vehicle 100 to directly or indirectly control the driving of the vehicle 100. However, the aspects described herein are not limited to implementation within autonomous or semi-autonomous vehicles, as these are provided by way of example. The aspects described herein may be implemented as part of any suitable type of vehicle that may be capable of travelling with or without any suitable level of human assistance in a particular driving environment. Therefore, one or more of the various vehicle components such as those discussed herein with reference to FIG. 2 for instance, may be implemented as part of a standard vehicle (i.e. a vehicle not using autonomous driving functions), a fully autonomous vehicle, and/or a semi-autonomous vehicle, in various aspects. In aspects implemented as part of a standard vehicle, it is understood that the safety system 200 may perform alternate functions, and thus in accordance with such aspects the safety system 200 may alternatively represent any suitable type of system that may be implemented by a standard vehicle without necessarily utilizing autonomous or semi-autonomous control related functions.

Regardless of the particular implementation of the vehicle 100 and the accompanying safety system 200 as shown in FIG. 1 and FIG. 2, the safety system 200 may include one or more processors 102, one or more image acquisition devices 104 such as, e.g., one or more vehicle cameras or any other suitable sensor configured to perform image acquisition over any suitable range of wavelengths, one or more position sensors 106, which may be implemented as a position and/or location-identifying system such as a Global Navigation Satellite System (GNSS), e.g., a Global Positioning System (GPS), one or more memories 202, one or more map databases 204, one or more user interfaces 206 (such as, e.g., a display, a touch screen, a microphone, a loudspeaker, one or more buttons and/or switches, and the like), and one or more wireless transceivers 208, 210, 212. Additionally or alternatively, the one or more user interfaces 206 may be identified with other components in communication with the safety system 200, such as one or more components of an ADAS unit, an AV system, etc., as further discussed herein.

The wireless transceivers 208, 210, 212 may be configured to operate in accordance with any suitable number and/or type of desired radio communication protocols or standards. By way of example, a wireless transceiver (e.g., a first wireless transceiver 208) may be configured in accordance with a Short-Range mobile radio communication standard such as e.g. Bluetooth, Zigbee, and the like. As another example, a wireless transceiver (e.g., a second wireless transceiver 210) may be configured in accordance with a Medium or Wide Range mobile radio communication standard such as e.g. a 3G (e.g. Universal Mobile Telecommunications System—UMTS), a 4G (e.g. Long Term Evolution-LTE), or a 5G mobile radio communication standard in accordance with corresponding 3GPP (3rd Generation Partnership Project) standards, the most recent version at the time of this writing being the 3GPP Release 16 (2020).

As a further example, a wireless transceiver (e.g., a third wireless transceiver 212) may be configured in accordance with a Wireless Local Area Network communication protocol or standard such as e.g. in accordance with IEEE 802.11 Working Group Standards, the most recent version at the time of this writing being IEEE Std 802.11™-2020, published Feb. 26, 2021 (e.g. 802.11, 802.11a, 802.11b, 802.11g, 802.11n, 802.11p, 802.11-12, 802.11ac, 802.11ad, 802.11ah, 802.11ax, 802.11ay, and the like). The one or more wireless transceivers 208, 210, 212 may be configured to transmit signals via an antenna system (not shown) using an air interface. As additional examples, one or more of the transceivers 208, 210, 212 may be configured to implement one or more vehicle to everything (V2X) communication protocols, which may include vehicle to vehicle (V2V), vehicle to infrastructure (V2I), vehicle to network (V2N), vehicle to pedestrian (V2P), vehicle to device (V2D), vehicle to grid (V2G), and any other suitable communication protocols.

One or more of the wireless transceivers 208, 210, 212 may additionally or alternatively be configured to enable communications between the vehicle 100 and one or more other remote computing devices via one or more wireless links 140. This may include, for instance, communications with a remote server the remote computing system 150 as shown in FIG. 1. The example shown FIG. 1 illustrates such a remote computing system 150 as a cloud computing system, although this is by way of example and not limitation, and the remote computing system 150 may be implemented in accordance with any suitable architecture and/or network and may constitute one or several physical computers, servers, processors, etc. that comprise such a system. As another example, the remote computing system 150 may be implemented as an edge computing system and/or network.

The one or more processors 102 may implement any suitable type of processing circuitry, other suitable circuitry, memory, etc., and utilize any suitable type of architecture. The one or more processors 102 may be configured as a controller implemented by the vehicle 100 to perform various vehicle-based functions, which may include for instance vehicle control functions, navigational functions, etc. For example, the one or more processors 102 may be configured to function as a controller for the vehicle 100 to analyze sensor data and received communications, to calculate specific actions for the vehicle 100 to execute for navigation and/or control of the vehicle 100, and to cause the corresponding action to be executed, which may be in accordance with an AV or ADAS system, for instance. For instance, once a particular vehicle-based function is determined based upon the environment, the current driving scenario, the current context, etc., the navigation system may cause actuation of one or more actuators of the host vehicle to implement the determined navigational action. Thus, the vehicle-based actuators that may be controlled as part of this process may include, for example, any suitable components of the vehicle 100 that may be used to implement a corresponding vehicle-based function such as steering actuators, braking actuators, acceleration and/or velocity actuators, etc.

Moreover, one or more of the processors 214A, 214B, 216, and/or 218 of the one or more processors 102 may be configured to work in cooperation with one another and/or with other components of the vehicle 100 to collect information about the environment (e.g., sensor data, such as images, depth information (for a Lidar for example), etc.). In this context, one or more of the processors 214A, 214B, 216, and/or 218 of the one or more processors 102 may be referred to as “processors.” The processors can thus be implemented (independently or together) to create mapping information from the harvested data, e.g., Road Segment Data (RSD) information that may be used for Road Experience Management (REM) mapping technology, the details of which are further described below. As another example, the processors can be implemented to process mapping information (e.g. roadbook information used for REM mapping technology) received from remote servers over a wireless communication link (e.g. link 140) to localize the vehicle 100 on an AV map, which can be used by the processors to control the vehicle 100.

The one or more processors 102 may include one or more application processors 214A, 214B, an image processor 216, a communication processor 218, and may additionally or alternatively include any other suitable processing device, circuitry, components, etc. not shown in the Figures for purposes of brevity. Similarly, image acquisition devices 104 may include any suitable number of image acquisition devices and components depending on the requirements of a particular application. Image acquisition devices 104 may include one or more image capture devices (e.g., cameras, charge coupling devices (CCDs), or any other type of image sensor). The safety system 200 may also include a data interface communicatively connecting the one or more processors 102 to the one or more image acquisition devices 104. For example, a first data interface may include any wired and/or wireless first link 220, or first links 220 for transmitting image data acquired by the one or more image acquisition devices 104 to the one or more processors 102, e.g., to the image processor 216.

The wireless transceivers 208, 210, 212 may be coupled to the one or more processors 102, e.g., to the communication processor 218, e.g., via a second data interface. The second data interface may include any wired and/or wireless second link 222 or second links 222 for transmitting radio transmitted data acquired by wireless transceivers 208, 210, 212 to the one or more processors 102, e.g., to the communication processor 218. Such transmissions may also include communications (one-way or two-way) between the vehicle 100 and one or more other (target) vehicles in an environment of the vehicle 100 (e.g., to facilitate coordination of navigation of the vehicle 100 in view of or together with other (target) vehicles in the environment of the vehicle 100), or even a broadcast transmission to unspecified recipients in a vicinity of the transmitting vehicle 100.

The memories 202, as well as the one or more user interfaces 206, may be coupled to each of the one or more processors 102, e.g., via a third data interface. The third data interface may include any wired and/or wireless third link 224 or third links 224. Furthermore, the position sensors 106 may be coupled to each of the one or more processors 102, e.g., via the third data interface.

Each processor 214A, 214B, 216, 218 of the one or more processors 102 may be implemented as any suitable number and/or type of hardware-based processing devices (e.g. processing circuitry), and may collectively, i.e. with the one or more processors 102 form one or more types of controllers as discussed herein. The architecture shown in FIG. 2 is provided for ease of explanation and as an example, and the vehicle 100 may include any suitable number of the one or more processors 102, each of which may be similarly configured to utilize data received via the various interfaces and to perform one or more specific tasks.

For example, the one or more processors 102 may form part of or the entirety of a controller that is configured to perform various vehicle-based functions, such as the calculation and execution of a specific vehicle following speed, velocity, acceleration, braking, steering, trajectory, etc. As another example, the vehicle 100 may, in addition to or as an alternative to the one or more processors 102, implement other processors (not shown) that may form a different type of controller that is configured to perform additional or alternative types of vehicle-based functions. Each controller may be responsible for controlling specific subsystems and/or controls associated with the vehicle 100. In accordance with such aspects, each controller may receive data from respectively coupled components as shown in FIG. 2 via respective interfaces (e.g. 220, 222, 224, 232, etc.), with the wireless transceivers 208, 210, and/or 212 providing data to the respective controller via the second links 222, which function as communication interfaces between the respective wireless transceivers 208, 210, and/or 212 and each respective controller in this example.

To provide another example, the application processors 214A, 214B may individually represent respective controllers that work in conjunction with the one or more processors 102 to perform specific vehicle-based functions. For instance, the application processor 214A may be implemented as a first controller, whereas the application processor 214B may be implemented as a second and different type of controller that is configured to perform other types of vehicle-based functions as discussed further herein. In accordance with such aspects, the one or more processors 102 may receive data from respectively coupled components as shown in FIG. 2 via the various interfaces 220, 222, 224, 232, etc., and the communication processor 218 may provide communication data received from other vehicles (or to be transmitted to other vehicles) to each controller via the respectively coupled links 240A, 240B, which function as communication interfaces between the respective application processors 214A, 214B and the communication processors 218 in this example. Of course, the application processors 214A, 214B may perform various functions as part of, in addition to, or as an alternative to the vehicle-based functions, such as the various processing functions as discussed herein, providing ADAS alerts, providing warnings regarding possible collisions, etc.

The one or more processors 102 may additionally be implemented to communicate with any other suitable components of the vehicle 100 to determine a state of the vehicle while driving or at any other suitable time, which may comprise an analysis of data representative of a vehicle status. For instance, the vehicle 100 may include one or more vehicle computers, sensors, ECUs, interfaces, etc., which may collectively be referred to as vehicle components 230 as shown in FIG. 2. The one or more processors 102 are configured to communicate with the vehicle components 230 via an additional data interface 232, which may represent any suitable type of links and operate in accordance with any suitable communication protocol (e.g. CAN bus communications). Using the data received via the data interface 232, the one or more processors 102 may determine any suitable type of vehicle status information such as the current drive gear, current engine speed, acceleration capabilities of the vehicle 100, etc. As another example, various metrics used to control the speed, acceleration, braking, steering, etc. may be received via the vehicle components 230, which may include receiving any suitable type of signals that are indicative of such metrics or varying degrees of how such metrics vary over time (e.g. brake force, wheel angle, reverse gear, etc.).

The one or more processors 102 may include any suitable number of other processors 214A, 214B, 216, 218, each of which may comprise processing circuitry such as sub-processors, a microprocessor, pre-processors (such as an image pre-processor), graphics processors, a central processing unit (CPU), support circuits, digital signal processors, integrated circuits, memory, or any other types of devices suitable for running applications and for data processing (e.g. image processing, audio processing, etc.) and analysis and/or to enable vehicle-based functions to be functionally realized. In some aspects, each processor 214A, 214B, 216, 218 may include any suitable type of single or multi-core processor, microcontroller, central processing unit, etc. These processor types may each include multiple processing units with local memory and instruction sets. Such processors may include video inputs for receiving image data from multiple image sensors, and may also include video out capabilities.

Any of the processors 214A, 214B, 216, 218 disclosed herein may be configured to perform certain functions in accordance with program instructions, which may be stored in the local memory of each respective processor 214A, 214B, 216, 218, or accessed via another memory that is part of the safety system 200 or external to the safety system 200. For example, any of the processors 214A, 214B, 216, 218, etc., may comprise any suitable circuitry and a local memory, which may store instructions that, when executed by the respective circuitry, cause the respective processor to perform various functions, which may include performing any aspect of the various embodiments as described herein, any aspects of the safety system 200, etc. This memory may additionally or alternatively include the one or more memories 202. Regardless of the particular type and location of memory, the memory may store software and/or executable (i.e. computer-readable) instructions that, when executed by a relevant processor (e.g., by the one or more processors 102, one or more of the processors 214A, 214B, 216, 218, the circuitry thereof, etc.), controls the operation of the safety system 200 and may perform any suitable functions such as vehicle-based functions or other functions, which may include those identified with the aspects as described in further detail herein.

A relevant memory accessed by the one or more processors 214A, 214B, 216, 218 (e.g. the one or more memories 202) may also store one or more databases and image processing software, as well as a trained system, such as a neural network, or a deep neural network, for example, that may be utilized to perform the tasks in accordance with any of the aspects as discussed herein. A relevant memory accessed by the one or more processors 214A, 214B, 216, 218 (e.g. the one or more memories 202) may be implemented as any suitable number and/or type of non-transitory computer-readable medium such as random-access memories, read only memories, flash memories, disk drives, optical storage, tape storage, removable storage, or any other suitable types of storage.

The components associated with the safety system 200 as shown in FIG. 2 are illustrated for ease of explanation and by way of example and not limitation. The safety system 200 may include additional, fewer, or alternate components as shown and discussed herein with reference to FIG. 2. Moreover, one or more components of the safety system 200 may be integrated or otherwise combined into common processing circuitry components or separated from those shown in FIG. 2 to form distinct and separate components. For instance, one or more of the components of the safety system 200 may be integrated with one another on a common die or chip. As an illustrative example, the one or more processors 102 and the relevant memory accessed by the one or more processors 214A, 214B, 216, 218 (e.g. the one or more memories 202) may be integrated on a common chip, die, package, etc., and together comprise a controller or system configured to perform one or more specific tasks or functions.

In some aspects, the safety system 200 may further include components such as a speed sensor 108 (e.g. a speedometer) for measuring a speed of the vehicle 100. The safety system 200 may also include one or more inertial measurement unit (IMU) sensors such as e.g. accelerometers, magnetometers, and/or gyroscopes (either single axis or multiaxis) for measuring accelerations of the vehicle 100 along one or more axes, and additionally or alternatively one or more gyro sensors, which may be implemented for instance to calculate the vehicle's ego-motion as discussed herein, alone or in combination with other suitable vehicle sensors. These IMU sensors may, for example, be part of the position sensors 105 as discussed herein. The safety system 200 may further include additional sensors or different sensor types such as an ultrasonic sensor, a thermal sensor, one or more radar sensors 110, one or more LIDAR sensors 112 (which may be integrated in the head lamps of the vehicle 100), digital compasses, and the like. The radar sensors 110 and/or the LIDAR sensors 112 may be configured to provide pre-processed sensor data, such as radar target lists or LIDAR target lists. The third data interface (e.g., one or more links 224) may couple the speed sensor 108, the one or more radar sensors 110, and the one or more LIDAR sensors 112 to at least one of the one or more processors 102.

### II. Autonomous Vehicle (AV) Map Data and Road Experience Management (REM)

Data referred to as REM map data (or alternatively as roadbook map data), may also be stored in a relevant memory accessed by the one or more processors 214A, 214B, 216, 218 (e.g. the one or more memories 202) or in any suitable location and/or format, such as in a local or cloud-based database, accessed via communications between the vehicle and one or more external components (e.g. via the transceivers 208, 210, 212), etc. It is noted that although referred to herein as “AV map data,” the data may be implemented in any suitable vehicle platform, which may include vehicles having any suitable level of automation (e.g. levels 0-5), as noted above.

Regardless of where the AV map data is stored and/or accessed, the AV map data may include a geographic location of known landmarks that are readily identifiable in the navigated environment in which the vehicle 100 travels. The location of the landmarks may be generated from a historical accumulation from other vehicles driving on the same road that collect data regarding the appearance and/or location of landmarks (e.g. “crowd sourcing”). Thus, each landmark may be correlated to a set of predetermined geographic coordinates that has already been established. Therefore, in addition to the use of location-based sensors such as GNSS, the database of landmarks provided by the AV map data enables the vehicle 100 to identify the landmarks using the one or more image acquisition devices 104. The vehicle 100 may implement other sensors such as LIDAR, accelerometers, speedometers, etc. or images from the image acquisitions device 104, to evaluate the position and location of the vehicle 100 with respect to the identified landmark positions.

Furthermore, and as noted above, the vehicle 100 may determine its own motion, which is referred to as “ego-motion.” Ego-motion is generally used for computer vision algorithms and other similar algorithms to represent the motion of a vehicle camera across a plurality of frames, which provides a baseline (i.e. a spatial relationship) that can be used to compute the 3D structure of a scene from respective images. The vehicle 100 may analyze the ego-motion to determine the position and orientation of the vehicle 100 with respect to the identified known landmarks. Because the landmarks are identified with predetermined geographic coordinates, the vehicle 100 may determine its position on a map based upon a determination of its position with respect to identified landmarks using the landmark-correlated geographic coordinates. Doing so provides distinct advantages that combine the benefits of smaller scale position tracking with the reliability of GNSS positioning systems while minimizing or avoiding the disadvantages of both systems. It is further noted that the analysis of ego motion in this manner is one example of an algorithm that may be implemented with monocular imaging to determine a relationship between a vehicle's location and the known location of known landmark(s), thus assisting the vehicle to localize itself. However, ego-motion is not necessary or relevant for other types of technologies, and therefore is not essential for localizing using monocular imaging. Thus, in accordance with the aspects as described herein, the vehicle 100 may leverage any suitable type of localization technology.

Thus, the AV map data is generally constructed as part of a series of steps, which may involve any suitable number of vehicles that opt into the data collection process. For instance, Road Segment Data (RSD) is collected as part of a harvesting step. As each vehicle collects data, the data is classified into tagged data points, which are then transmitted to the cloud or to another suitable external location. A suitable computing device (e.g. a cloud server) then analyzes the data points from individual drives on the same road, and aggregates and aligns these data points with one another. After alignment has been performed, the data points are used to define a precise outline or geometry of the road infrastructure. Next, relevant semantics are identified that enable vehicles to understand the immediate driving environment, i.e. features and objects are defined that are linked to the classified data points. The features and objects defined in this manner may include, for instance, traffic lights, road arrows, signs, road edges, drivable paths, lane split points, stop lines, lane markings, etc. to the driving environment so that a vehicle may readily identify these features and objects using the AV map data. This information is then compiled into a Roadbook Map, which constitutes a bank of driving paths, semantic road information such as features and objects, and aggregated driving behavior.

A map database 204, which may be stored as part of the one or more memories 202 or accessed via the remote computing system 150 via the link(s) 140, for instance, may include any suitable type of database configured to store (digital) map data for the vehicle 100, e.g., for the safety system 200. The one or more processors 102 may download information to the map database 204 over a wired or wireless data connection (e.g. the link(s) 140) using a suitable communication network (e.g., over a cellular network and/or the Internet, etc.). Again, the map database 204 may store the AV map data, which includes data relating to the position, in a reference coordinate system, of various landmarks such as objects and other items of information, including roads, and objects that may be relevant for supporting the navigation or safety functions implemented by the safety system 200. Optionally, the AV map may include information, and specifically location information, which is not directly or exclusively related to a function of the safety system 200, such as information about businesses, water features, points of interest, etc.

The map database 204 may thus store, as part of the AV map data, not only the locations of such landmarks, but also descriptors relating to those landmarks, including, for example, names associated with any of the stored features, and may also store information relating to details of the items such as a precise position and orientation of items. In some cases, the AV map data may store a sparse data model including polynomial representations of certain road features (e.g., lane markings) or target trajectories for the vehicle 100. The AV map data may also include stored representations of various recognized landmarks that may be provided to determine or update a known position of the vehicle 100 with respect to a target trajectory. The landmark representations may include data fields such as landmark type, landmark location, etc., among other potential identifiers. The AV map data may also include non-semantic features including point clouds of certain objects or features in the environment, and feature point and descriptors.

The map database 204 may be augmented with data in addition to the AV map data, and/or the map database 204 and/or the AV map data may reside partially or entirely as part of the remote computing system 150. As discussed herein, the location of known landmarks and map database information, which may be stored in the map database 204 and/or the remote computing system 150, may form what is referred to herein as “AV map data,” “REM map data” or “Roadbook Map data.” The one or more processors 102 may process sensory information (such as images, radar signals, depth information from LIDAR or stereo processing of two or more images) of the environment of the vehicle 100 together with position information, such as GPS coordinates, the vehicle's ego-motion, etc., to determine a current location, position, and/or orientation of the vehicle 100 relative to the known landmarks by using information contained in the AV map. The determination of the vehicle's location may thus be refined in this manner. Certain aspects of this technology may additionally or alternatively be included in a localization technology such as a mapping and routing model.

### III. Safety Driving Model

Furthermore, the safety system 200 may implement a safety driving model or SDM (also referred to as a “driving policy model,” “driving policy,” or simply as a “driving model”), e.g., which may be utilized and/or executed as part of the ADAS system as discussed herein. By way of example, the safety system 200 may include (e.g. as part of the driving policy) a computer implementation of a formal model such as a safety driving model. A safety driving model may include an implementation of a mathematical model formalizing an interpretation of applicable laws, standards, policies, etc. that are applicable to self-driving (e.g., ground) vehicles. In some embodiments, the SDM may comprise a standardized driving policy such as the Responsibility Sensitivity Safety (RSS) model. However, the embodiments are not limited to this particular example, and the SDM may be implemented using any suitable driving policy model that defines various safety parameters that the AV should comply with to facilitate safe driving.

For instance, the SDM may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic, and in turn limit the scalability of system deployment; and third, the interpretation should be efficiently verifiable in the sense that it can be rigorously proven that the self-driving (autonomous) vehicle correctly implements the interpretation of the law. An implementation in a host vehicle of a safety driving model (e.g. the vehicle 100) may be or include an implementation of a mathematical model for safety assurance that enables identification and performance of proper responses to dangerous situations such that self-perpetrated accidents can be avoided.

A safety driving model may implement logic to apply driving behavior rules such as the following five rules:
Do not hit someone from behind.
Do not cut-in recklessly.
Right-of-way is given, not taken.
Be careful of areas with limited visibility.
If you can avoid an accident without causing another one, you must do it.

It is to be noted that these rules are not limiting and not exclusive, and can be amended in

various aspects as desired. The rules thus represent a social driving “contract” that might be different depending upon the region, and may also develop over time. While these five rules are currently applicable in most countries, the rules may not be complete or the same in each region or country and may be amended.

As described above, the vehicle 100 may include the safety system 200 as also described with reference to FIG. 2. Thus, the safety system 200 may generate data to control or assist to control the ECU of the vehicle 100 and/or other components of the vehicle 100 to directly or indirectly navigate and/or control the driving operation of the vehicle 100, such navigation including driving the vehicle 100 or other suitable vehicle-based functions as further discussed herein. This navigation may optionally include adjusting one or more SDM parameters, which may occur in response to the detection of any suitable type of feedback that is obtained via image processing, sensor measurements, etc. The feedback used for this purpose may be collectively referred to herein as “environmental data measurements” and include any suitable type of data that identifies a state associated with the external environment, the vehicle occupants, the vehicle 100, and/or the cabin environment of the vehicle 100, etc.

For instance, the environmental data measurements may be used to identify a longitudinal and/or lateral distance between the vehicle 100 and other vehicles, the presence of objects in the road, the location of hazards, etc. The environmental data measurements may be obtained and/or be the result of an analysis of data acquired via any suitable components of the vehicle 100, such as the one or more image acquisition devices 104, the one or more position sensors 105, the position sensors 106, the speed sensor 108, the one or more radar sensors 110, the one or more LIDAR sensors 112, etc. To provide an illustrative example, the environmental data may be used to generate an environmental model based upon any suitable combination of the environmental data measurements. Thus, the vehicle 100 may utilize the tasks performed via trained model(s) to perform various navigation-related operations within the framework of the driving policy model. These navigational-related operations may alternatively be referred to herein as navigational actions or as vehicle-based functions, which are described in further detail herein.

The navigation-related operation may be performed, for instance, by generating the environmental model and using the driving policy model in conjunction with the environmental model to determine an action to be carried out by the vehicle. That is, the driving policy model may be applied based upon the environmental model to determine one or more actions (e.g. vehicle-based functions such as navigation-related operations) to be carried out by the vehicle. The SDM can be used in conjunction (as part of or as an added layer) with the driving policy model to assure a safety of an action to be carried out by the vehicle at any given instant. For example, the ADAS may leverage or reference the SDM parameters defined by the safety driving model to determine navigation-related operations of the vehicle 100 in accordance with the environmental data measurements depending upon the particular scenario. The navigation-related operations may thus cause the vehicle 100 to execute a specific action based upon the environmental model to comply with the SDM parameters defined by the SDM model as discussed herein. For instance, navigation-related operations may include steering the vehicle 100, changing an acceleration and/or velocity of the vehicle 100, executing predetermined trajectory maneuvers, etc. In other words, the environmental model may be generated at least in part on sensor data received via the various sensors of the vehicle 100 as noted herein, and the applicable driving policy model may then be applied together with the environmental model to determine a navigation-related operation to be performed by the vehicle.

### IV. Noise Model Based Compression

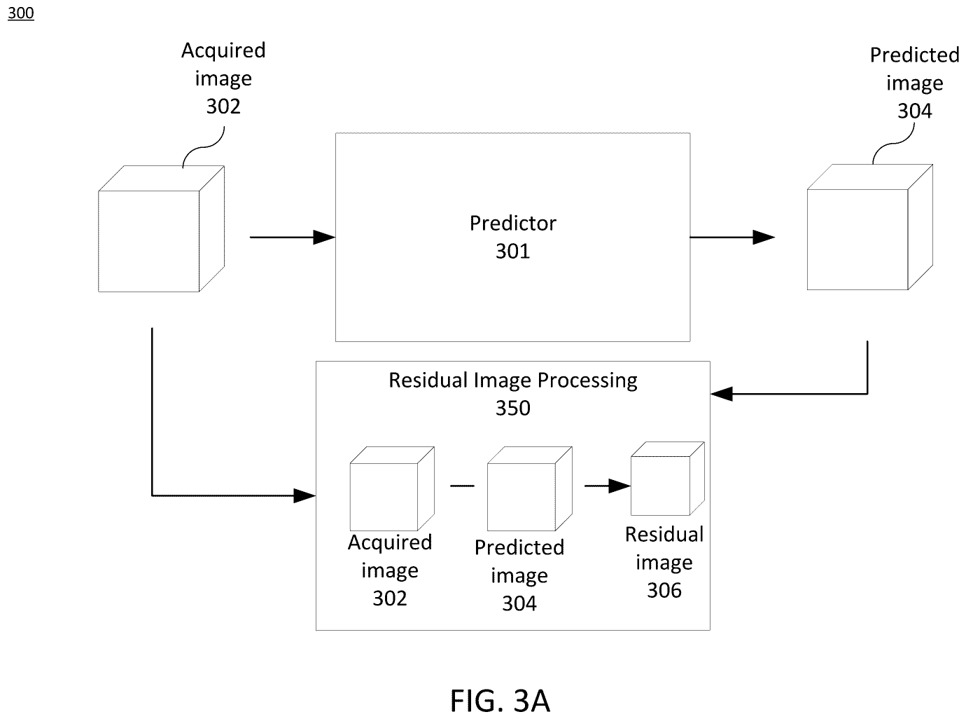

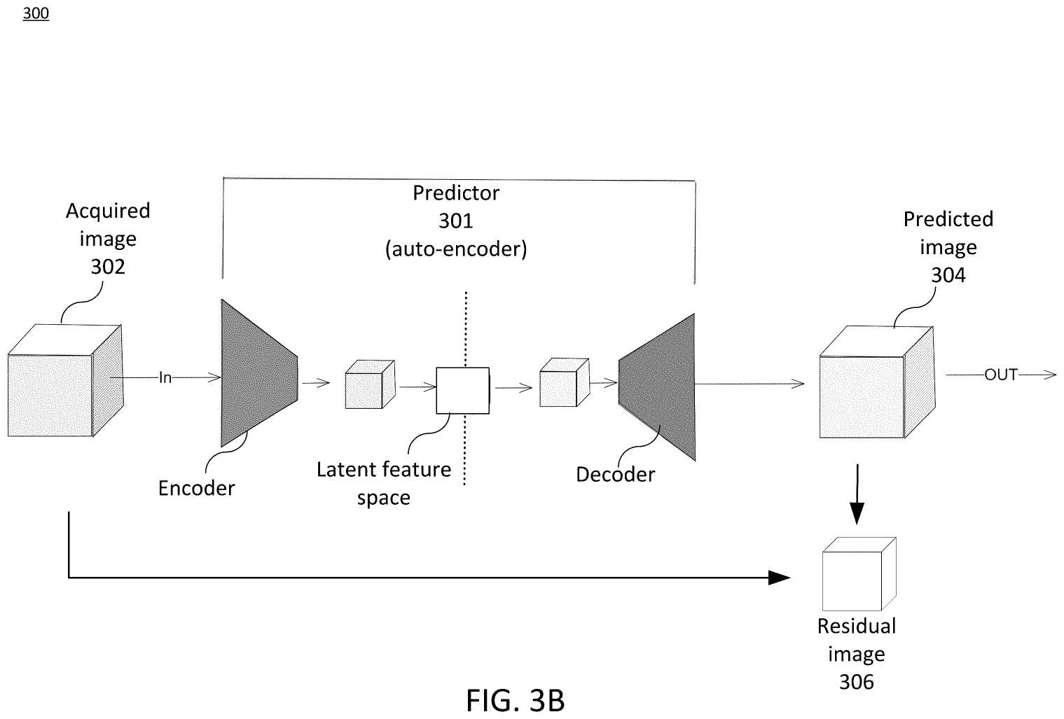

FIGS. 3A-3B illustrate the use of predictors to generate a predicted image from an acquired image. FIG. 3A illustrates the use of a general predictor 301, which may comprise any suitable type of predictor mechanism. This may include, as a non-limiting and illustrative example, an auto-encoder as shown in FIG. 3B. The embodiments as described herein are not limited to such implementations, however, and may utilize any suitable type of prediction mechanisms that generate predicted images used to generate compressible residual images.

In any event, the predictor 301 as discussed herein may be implemented, for instance, via any suitable computing device and/or processing circuitry identified with the vehicle 100 and/or the safety system 200. This may include, for example, the one or more processors 102, one or more of the processors 214A, 214B, 216, 218, etc., executing instructions stored in a suitable memory (e.g. the one or more memories 202). The predictor 301 may alternatively be implemented by any suitable computing device that may be separate from the vehicle 100.

For example, the predictor 301 may comprise a differential pulse-code modulation (DPCM) predictor, which is commonly used to enable lossless compression for the various Joint Photographic Experts Group (jpeg) standards. To provide additional examples, the predictor 301 may be implemented as a LOCO (LOw COmplexity LOssless Compression) predictor, which is implemented for lossless and near lossless jpeg standards. Still further, the predictor 301 may be implemented using any suitable type of neural network, machine learning, and/or deep learning algorithm.

FIG. 3B illustrates the use of an auto-encoder system as the predictor 301 to perform image compression. The predictor 301, which comprises as an auto-encoder in this example, may be implemented as any suitable type of neural network having several different layers, e.g. several input layers, hidden layers, convolutional layers, output layers, etc., and is trained to perform predictions regarding the input data. The input data in the examples discussed herein comprises any suitable number of acquired images, with a single acquired image 302 being shown in FIG. 3B for ease of explanation, which may comprise an image associated with a single frame. The predictor 301 may receive any suitable number of acquired images over several frames in accordance with a particular frame rate. Thus, during training, the acquired image 302 may comprise one of several images that form a set of training data, which may represent images similar to those expected to be obtained during deployment of the trained system.

Thus, the encoder portion of the auto encoder is trained to perform downsampling, filtering, convolutions, etc., to compute a smaller representation of the acquired image 302, which is represented in the example shown in FIG. 3B as the latent feature space. Thus, the encoder portion of the auto encoder is trained to generate the latent feature space in an efficient manner, which may include the implementation of tools such as dimensionality reduction, for instance.

The decoder portion of the auto encoder is trained to expand or decompress the latent feature space back into the original acquired image 302. Thus, from an end-to-end standpoint, the predictor 301 may be trained as any suitable type of machine learning model (e.g. an unsupervised machine learning model) that attempts to capture a difference (i.e. loss) between an output image (i.e. the predicted image 304) and the original acquired image 302. Thus, the auto encoder in this example is trained to generate the predicted image 304 in a manner that minimizes this loss.

Once trained, the predictor 301 may be deployed in any suitable environment and/or application. For example, if deployed as part of the safety system 200, then the predictor 301 may be configured to generate predicted images 304 from acquired images 302. In this context, the acquired images 302 may be obtained via any suitable source, such as a camera of the vehicle 100 for instance. When used as part of an AV system, such as one associated with the vehicle 100 as discussed above for instance, the acquired image 302 may be obtained via one of the image acquisition devices 104, for example, as shown and discussed above with respect to FIGS. 1 and 2. Again, the acquired image 302 may comprise a single frame from among several frames that are acquired within a driving environment, which are captured via a camera (e.g. one of the image acquisition devices 104) during operation of the vehicle in accordance with a particular frame rate.

In any event, the residual image 306 represents the difference between the acquired image 302 and the predicted image 304. Thus, and as shown in FIG. 3A, the residual image processing block 350 may be implemented, for instance, via any suitable computing device and/or processing circuitry, which may include those identified with the predictor 301, the vehicle 100, and/or the safety system 200 or other suitable computing system. This may include, for example, the one or more processors 102, one or more of the processors 214A, 214B, 216, 218, etc., executing instructions stored in a suitable memory (e.g. the one or more memories 202). In other words, the residual image processing block 350 generates the residual image 306 by subtracting the predicted image 304 out of the acquired image 302. This may include, for instance, subtracting the predicted image 304 from the acquired image 302 on a per-pixel basis, e.g. by subtracting the corresponding pixel values of the predicted image 304 from the acquired image 302. Thus, the size of the residual image 306 is smaller when the predictor 301 provides a better prediction, and the residual image 306 may in turn be compressed more easily with more accurate predictions. For instance, the residual image 306 may comprise all zeroes when a “perfect” prediction is made by the predictor 301, as in this case the predicted image 304 is the same as the acquired image 302. The residual image 306 also has a lower entropy compared to the acquired image 302.

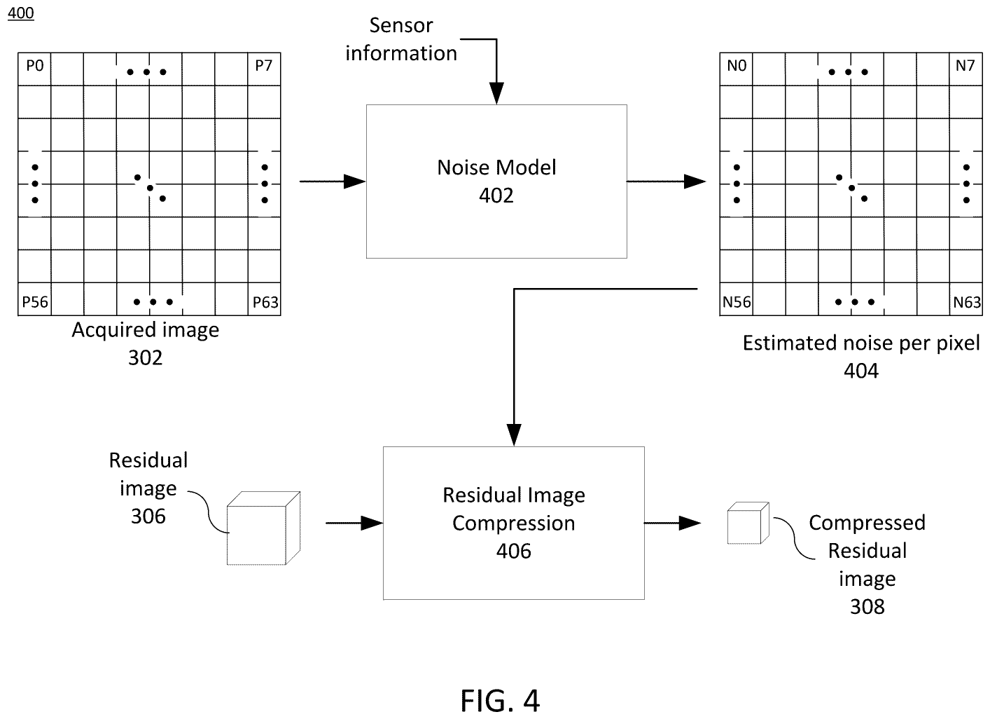

As a result, the residual image 306 may be further compressed to form the compressed residual image 308, as shown and discussed in further detail below with respect to FIG. 4. The compressed residual image 308 may then be stored in any suitable manner, which may include storage in any suitable component of the vehicle 100, for example, such as the one or more memories 202. Alternatively, the compressed residual image 308 may be stored in any suitable manner remote from the vehicle 100, such as in the remote computing system 150, for example. The compressed residual image 308 may then be subsequently accessed, decompressed, and used to restore the acquired image 302 by combining (e.g. summing) the predicted image 304 and the residual image 306. This summation may include, for instance, adding the predicted image 304 from the acquired image 302 on a per-pixel basis, e.g. by adding the corresponding pixel values of the predicted image 304 and the acquired image 302.

Thus, the use of residual images 306 advantageously allows for a compression of the acquired image 302. Therefore, regardless of the type of predictor 301 that is utilized, the embodiments as further discussed herein function to perform an efficient compression of residual images 306 based upon noise model information that is associated with the source of the originally acquired image 302. To this end, it is noted that conventional residual image compression techniques leverage “near-lossless” compression settings by allowing for some error to exist in the resulting compressed residual image. To ensure that this error is acceptable, such conventional techniques include defining (i.e. bounding) a maximal reconstruction error by reducing the resolution in which the residual image 306 is saved.

In other words, the residual image 306 is compressed by reducing its resolution, and this compressed residual image 308 may then be stored in any suitable location. Then, at a subsequent time, the acquired image 302 may be reconstructed using the stored compressed residual image 308 and the predicted image 304. This reconstructed image may then be used for any suitable purpose by the vehicle 100 or another suitable computing system. For example, the reconstructed acquired image may be added to a training data set that includes several hundred, several thousand, several million, etc., images, which is used to train a machine learning model, a neural network, etc., to perform specific tasks. Such tasks may comprise, for instance, vehicle-based functions such as any of those discussed herein, which may include for instance object classification, perception, etc.

A common technique to perform this reduction in resolution is to drop (i.e. zero out) the last N bits of data used to encode each pixel in the residual image 306, which may include the last N least significant bits (LSBs). For example, the residual image 306 may comprise any suitable number of pixels, with each pixel representing an encoded value per color channel such as 0-255 for RGB encoding. In this case, the value of each pixel of the residual image 306 is encoded using M bits, with M=8 in this example, per color (e.g. 255=11111111). By dropping the last N bits of the entire M bits used for pixel value encoding, this results in bounding the maximal error of the compressed residual image by 2^{N-1}. As an illustrative example, if the last 2 LSBs of each encoded value of the residual image 306 are dropped by zeroing these values (e.g. 11111100), then the maximal reconstructed error will be no larger than 2.

Thus, the embodiments as described herein recognize that dropping additional bits of the residual image 306 will result in lower entropy values, which allows for a higher compression of the residual image 306 prior to being stored. However, current residual image compression techniques drop the same number of bits per each pixel across the entirety of the residual image 306, which results in a uniform reduction in resolution of the residual image pixel values. In other words, conventional techniques for compressing residual images are not adaptative, as such techniques function to remove the same amount of information per each pixel, and do not utilize information regarding the sensor used to obtain the acquired images.

In contrast, the embodiments described herein leverage additional information from the source sensor used to obtain the acquired image 302 to optimize or at least improve upon the level of compression that may be applied while not increasing the maximal reconstruction error. This is achieved by exploiting noise model information that is correlated to the type of sensor used to capture the acquired image 302. For instance, the image 302 may be acquired via one of the image acquisition devices 104, which again may comprise a vehicle camera. Each image acquisition device 104 may have corresponding intrinsic properties that are known in advance by the relevant system (e.g. the safety system 200), which may consider various parameters such as the sensor type, the sensor configuration, settings, optical properties (e.g. optical properties of the camera lens), etc.

The noise model 402 may be generated via any suitable computing device and/or processing circuitry, which may for example be identified with the vehicle 100, the safety system 200, and/or other suitable computing device. In any event, the noise model 402 may be generated utilizing any suitable parameters of the sensor that is used to provide the acquired image 302, and which are known to impact the noise level of the acquired images. To provide additional examples, such parameters may comprise gain, exposure, and sensor temperature, which all affect the noise level of an acquired frame per brightness level.

Turning now to FIG. 4, a noise model 402 is generated for any suitable number of sensors from which the acquired images 306 are obtained during operation, as further discussed herein. The noise model 402 may comprise, for instance, a statistical noise model or any other suitable noise model. Additionally or alternatively, the noise model 402 may comprise a machine learning trained model. Thus, the noise model 402 may comprise a statistical model, a machine learning trained model, or combinations of these. The noise model 402 may comprise any suitable number and/or type of model(s) that are generated based upon a training process, for instance, that utilizes sensor information (also referred to herein as sensor parameters) that is associated with the sensor that generated the acquired image 302. In other words, although the noise model 402 is primarily described herein as a machine learning trained model, this is by way of example and not limitation. Thus, in some embodiments, the noise model 402 may be generated per frame without any pre-training, or alternatively be trained using any suitable portion of parameters of the sensor that are used to provide the acquired image 302. The noise model 402 may comprise any suitable type of model in addition to or instead of a machine learning trained model, with alternate types requiring no pre-training as noted above.

The statistical model may be generated to use any suitable number and/or combination of sensor parameters to enable an accurate yet statistical prediction of the expected noise level of the acquired image 302. In various embodiments, the sensor parameters in this context may include, for example, the above-referenced intrinsic properties of the sensor, which may include any suitable combination of the sensor parameters described herein. The sensor parameters may also include information regarding the configuration of the sensor, which may include for example exposure values or any other suitable information regarding the sensor configuration. In this way, the noise model 402 may be trained or otherwise generated in accordance with any suitable combination of the intrinsic properties and/or sensor configuration data associated with any suitable number of sensors from which the acquired image 302 is anticipated to be acquired. Then, once deployed, the trained noise model 402 may receive the acquired image 302 as well as the sensor information associated with the sensor, as shown in FIG. 4, which are used by the noise model 402 to compute the estimated noise per pixel 404 as shown.

The noise model 402 may thus represent any suitable type of trained model and be implemented, for instance, via a suitable computing device and/or processing circuitry identified with the vehicle 100 and/or the safety system 200. The noise model 402 may be generated in any suitable manner using the intrinsic properties of a particular sensor, which may comprise the use of a neural network, machine learning, deep learning, etc. As one example, the noise model 402 may be generated as a physical-based noise model that utilizes any suitable known parameters, e.g. those discussed above such as gain, exposure, sensor temperature, etc. A physical-based noise model 402 may function to predict the noise distribution for a particular sensor, which may be defined in accordance with any suitable techniques. For instance, the noise for such a physical-based noise model 402 may primarily be defined in accordance with a standard deviation that considers the primary noise source (e.g. shot noise, readout noise, etc.) using information regarding the known physical properties of a particular sensor. Thus, such physical-based noise model are analytical in nature and are as accurate as the assumptions regarding the sensor's operation (e.g. the aforementioned parameters).

Therefore, the noise model 402 may alternatively be generated using any suitable type of machine learning process. To train such a learning-based noise model 402, the noise model 402 may receive, as inputs, acquired images and each acquired image's respective metadata and provide, as outputs, the estimated noise per pixel. The images used to train the noise model in this way may be provided by a sensor that is identical to, the same model as, or otherwise operates in a similar manner as the sensor from which the acquired images 302 are received during deployment of the noise model 402 in the vehicle 100. Any suitable training process may be implemented to train such a learning-based noise model 402. These may include, for instance, supervised or unsupervised training processes.

As an illustrative example, a supervised training process may include the generation of a calibrated dataset of images of known “scenes,” to facilitate the estimation of a ground truth noise. Then, the exact same scene may be captured with different sensor configurations (for example by varying the exposure) to infer the noise per pixel for newly acquired images 302. The information regarding the different sensor configurations per scene may thus be included as part of the metadata in parallel with the received images as part of the model training process. Thus, once trained, the learning-based noise model 402 may, during inference, match the image metadata associated with newly acquired images 304, which identifies the sensor configuration used to acquire the images 304, to the same images during training that were acquired using that same sensor configuration.

As another illustrative example, unsupervised processes such as adversarial or contrastive learning may be implemented. This may include, for instance, generating noisy images in parallel with “clean” images via any suitable data source. Then, the noise model 402 may be trained in accordance with any suitable techniques for adversarial or contrastive learning, including known techniques, which may leverage a discriminator to distinguish between such images to facilitate the training process for the learning-based noise model 402.

Although any suitable techniques may be implemented to generate the noise model 402, using the machine learning process to train the noise model 402 may be particularly advantageous. This is because doing so may yield a noise model 402 that is capable of automatically deducing hidden physical relationships between pixels, image metadata, and their respective noise to provide for more accurate noise predictions based upon real-world usage. Such relationships may otherwise be difficult or impossible to code manually as part of an analytical physical-based noise model.

As noted above, the acquired images 302 may be provided by or otherwise received from any suitable image sensor of the vehicle, such as the image acquisition devices 104 for instance. Additionally or alternatively, the acquired images 302 may be generated by one or more virtual sensors. For instance, the same configuration settings and/or known physical properties of a physical sensor may be used to generate a model of that same sensor. Such a virtual sensor model may be generated in any suitable manner, such as a digital twin of a sensor or using any suitable modeling construct, which may be identified with a real sensor or a sensor that does not physically exist. Once generated in this manner, the noise model 402 may then be used to generate the estimated noise per pixel, as discussed herein, and any of the embodiments as discussed herein may apply equally to the generation of acquired images 302 via such a virtual sensor. Such embodiments may be particularly useful to draw conclusions from sensor performance using known parameters of a candidate camera system that may be under consideration prior to its installation in the vehicle 100.

Thus, the noise model 402 is configured to estimate any suitable type of noise associated with the sensor from which the acquired image 302 was received based upon the manner in which the noise model 402 was trained. This may include, for instance, the estimation of quantization noise, shot noise, thermal noise, etc., such that the noise model 402 predicts a specific noise value N0 . . . N63 per pixel in the acquired image 302, as shown in FIG. 4. In other words, the noise model 402 may predict, as the estimated noise per pixel as shown in FIG. 4, any suitable type of noise based upon the configuration of the noise model 402 and the training data on which the noise model 402 is trained to predict for each received acquired image 302.

In this way, the noise model 402 is configured to estimate a noise level in each pixel of the acquired image 302, which may correspond to any suitable number and/or type of noise. Embodiments include the use of a residual image compression block 406. Again, the residual image compression block 406 may be implemented, for instance, via any suitable computing device and/or processing circuitry, which may for example be identified with the vehicle 100, the safety system 200, and/or other suitable computing device. The residual image compression block 406 receives the residual image 306 and the estimated noise per pixel information 404 as shown in FIG. 4.

The residual image compression block 406 leverages the estimated noise per pixel information 404, which is output via the noise model, to limit the number of bits dropped per pixel to be equal to the estimated noise per pixel. As a result, when the residual image 306 is used to generate a reconstructed image of the acquired image 302, this reconstructed image is just as noisy as the original acquired image 302 when considering the noise introduced into the acquired image via the corresponding sensor. Thus, when compressed in this manner, the compressed residual image 308 includes a level of noise that is equal to that of the originally acquired image 302. And when reconstruction is subsequently applied to obtain the acquired image 302, the process is more efficient compared to conventional residual compression techniques, because the noise present in the originally acquired image 302 is not reconstructed as part of this process.

Thus, FIG. 4 illustrates the process of estimating the noise per pixel in the acquired image 302 as part of the compression of the residual image 306. To do so, during compression, the originally acquired image 302 is provided as an input to the noise model 402. As a result, an estimation of noise (i.e. an encoded value) per pixel in the acquired image 302 is output by the noise model 402. Again, this is represented in FIG. 4 as the estimated noise per pixel information 404. For the example shown in FIG. 4, an acquired image 302 is shown having a total of 64 pixels for ease of explanation. However, the embodiments described herein may of course be expanded to acquired images having any suitable number of pixels depending upon the particular application.

Thus, the estimated noise values N0-N63 associated with the estimated noise per pixel information 404 as shown in FIG. 4 represent a per-pixel estimated noise value output by the noise model 402. These per-pixel noise estimations represent a noise value that is within the same range of the values used to encode the pixel values P0-P63 of the acquired image 302. In other words, the pixel values P0-P63 may represent an encoded value that represents a linear combination of a signal value and a noise value, and the noise model 402 is configured to estimate the noise contribution to each of the encoded pixel values P0-P63.

The residual image compression block 406 uses the per-pixel estimated noise values N0-N63 to compute a minimum number of bits required to encode them. For example, a value of 2 bits would be required to encode a noise value of 4, a value of 3 bits would be required to encode a noise value of 7, etc. This process may be repeated by the residual image compression block 406 to compute, for each pixel of the acquired image 302, a corresponding bit value required to encode each estimated noise level. Then, the residual image compression block 406 may generate the compressed residual image 308 by dropping a number of bits per pixel (e.g. a number of least significant bits (LSBs)) from each pixel of the residual image 306 that is equal to each respective bit value required to encode each estimated noise level per pixel.

To provide an illustrative example, noise values of 4 and 7 for N0 and N7, respectively, would result in the residual image compression block 406 dropping 2 LSBs for the pixel associated with the noise value N0, and dropping 3 LSBs for the pixel associated with the noise value N7. Thus, to perform the residual image compression, for each pixel in the residual image 306, as many bits are dropped (i.e. zeroed) as the noise model 402 allows. In this way, the comprised residual image 306 may be generated by dropping LSBs from the residual image 306 that are used to encode each pixel. Again, this is done on a pixel-by-pixel basis in accordance with the corresponding bit value per pixel that is required to encode the estimated noise level in the acquired image 302, thereby achieving a non-uniform reduction in resolution across the pixels of the residual image 306.

Again, the acquired image 302 may be subsequently restored from the compressed residual image 308. When this is done, the reconstructed image will advantageously be “perceptually lossless,” because the noise induced by the compression process as discussed herein will be no higher than the noise induced by the sensor itself. In other words, the reconstructed image will be just “as likely” as the originally acquired image 302. In this context, it is further noted that the compressed residual image 308 generated via the embodiments as discussed herein may represent a slightly lossy compression of the residual image 306 due to dropping the pixel LSB values as noted herein. However, these losses are significantly less than conventional lossy compression algorithms by way of leveraging the noise model 402 to generate the estimated noise per pixel. As a result, such losses may be considered negligible as the compressed residual image 308, when used to generate the reconstructed image, still yields a reconstructed image that is perceptually lossless. This is because the noise model 402 functions to limit the amount of noise that may be contained in the compressed residual image 308 by way of the compression performed via the residual compression block 406. It would be appreciated that the notion of a “perceptually lossless” compression is particularly valuable for a system such as safety system 200 or any similar vision-based detection system (e.g., a visible light camera based system), which is intended to detect and interpret the semantic meaning of objects in a manner that is similar to what a human would detect and understand from a scene. The human vision system has certain limitations or characteristics that are not fully reflected in what is commonly termed “lossless compression” and “perceptually lossless” techniques can use “lossless compression” in a manner that does not (or does so minimally) compromise the ability of any vision based detection system that uses such images to perform at a level that a human would have (as a minimum).

Again, it is noted that the residual image 308 may be subsequently accessed, decompressed, and used to generate the reconstructed image by combining (e.g. summing) the predicted image 304 and the residual image 306 (which is obtained by decompressing the compressed residual image 308). In this context, “perceptually lossless” with respect to the reconstructed image means that a distinction may not be made by a human observer with respect to reconstructed images and the initial acquired images 302 used to generate the compressed residual images 308. Again, any noise introduced into the compressed residual image 308 by way of the residual image compression block 406 (e.g. due to the losses via dropping the LSBs per pixel) is the same as any noise that is already produced via the image sensor (e.g. one of the image acquisition devices 104 that is generating the acquired images 302).

Additionally, perceptually lossless in this context also means that a distinction may not be made by the computer vision algorithms implemented via the safety system 200 to perform any vehicle-based functions as discussed herein. For instance, the safety system 200 may use the reconstructed images to perform any suitable type of vehicle-based functions such as any suitable type of control-based functions, detecting and/or classifying features and/or objects within a driving environment, performing predictions, using the classified features and/or objects to perform control-based functions such as vehicle navigation, issuing alerts, issuing warnings of other information based upon the classified objects and/or features, identifying and/or executing vehicle maneuvers, calculating vehicle trajectories, etc., any of the other vehicle-based functions as discussed herein, etc.

In accordance with the embodiments described herein, the limitation of the noise in the compressed residual image 308 facilitates any suitable vehicle functions being performed using the reconstructed images. Thus, such vehicle-based functions may result in the same classifications, probabilities, calculations, etc., using the reconstructed images that would result from the computer vision algorithms being performed using the acquired images 302. In this way, the residual image compression block 406 may introduce losses that are not perceived by a human or by a CV algorithm by way of the limitation of the noise contained in the compressed residual image 308 via the use of the noise model 402. In other words, the reconstructed images may have some loss compared to the acquired images 302. However, this loss is negligible, and such reconstructed images are considered perceptually lossless in that the CV algorithms executed via the safety system 200 allow for the vehicle-based functions to be performed with respect to reconstructed images having the same probability as vehicle-based functions performed with respect to the acquired images 302.

It is noted that the above examples describe dropping a number of LSBs for each pixel based upon that pixel's corresponding noise value that is obtained via the noise model 402. For each of these illustrative examples, the number of pixels dropped is equal to the bit value (i.e. the number of bits) required to encode each estimated noise level per pixel. However, the number of bits dropped in this manner may be less than the number of bits required to encode the noise of each pixel. Thus, the number of bits required to encode each estimated noise level per pixel may represent a maximum number of bits to be dropped that are “allowed” by the noise model 402, although a lesser number of bits may be dropped in other embodiments.

Such embodiments may be particularly useful, for instance, when the predictions provided by the noise model 402 are anticipated to be less accurate based upon various factors, a lack of information or parameters from the intrinsic properties of the sensor, etc. In such a case, a larger “safety margin” may be implemented by removing a number of bits that is less than the maximum allowed by the noise model prediction. For instance, a “buffer” of one bit may be implemented such that, using the above example, the residual image compression block 406 would drop 1 LSB (i.e. 1 less than the maximum of 2 LSBs) for the pixel associated with the noise value N0 and drop 2 LSBs (i.e. 1 less than the maximum of 3 LSBs) for the pixel associated with the noise value N7. Any suitable buffer bit value may be used in such scenarios by accepting a tradeoff between compressibility of the residual image 306 and the ability to accurately restore the initially acquired image 302.

### V. Extension of Noise Model Based Compression to High Dynamic Range (HDR) Applications

The embodiments described above have been described with respect to the compression of the residual image 306 from the acquired image 302, which again may comprise one of several images acquired via a suitable sensor. The acquired image 302 may comprise any suitable type of image that comprises several pixels, as discussed herein. In accordance with various embodiments, the acquired image 302 may comprise HDR images or non-HDR images.

When the acquired image 302 comprises an HDR image, the embodiments as discussed herein may advantageously utilize information from the HDR processing pipeline of the relevant sensor from which the acquired image 302 is received to further optimize the operation of the residual image compression block 406. Thus, the noise model 402 may be generated using such information in addition to or instead of the other various techniques as discussed above. For example, the noise model 402 may be generated using sensor information, as shown in FIG. 4 and discussed above, and this sensor information may include any suitable type of information regarding the HDR processing pipeline used to generate the acquired image 302.

Such HDR processing pipeline information may include, for instance, information regarding the companding process used to generate the acquired image 302 or any other suitable information as discussed herein. Thus, in various embodiments, the acquired image 302 may comprise an HDR image that has been companded or, alternatively, a non-companded HDR image. The HDR companding process is a known technique by which HDR images may essentially be compressed as lower resolution images for storage and/or transmission within an applicable system, and may then be expanded to their original resolution via an applicable component. This companding process may be performed via the image sensor (e.g. one of the image acquisition devices 104 that is generating the acquired images 302) or any suitable components of the vehicle 100 as discussed herein. The details of the companding process are not shown in further detail, as such processes are generally known, and thus a further description need not be provided in further detail for purposes of brevity.

As an illustrative example, the acquired image 302 may comprise a companded HDR image, such as 12 bits per pixel as an illustrative example that was the result of any suitable companding process (e.g. linear companding) being performed on a higher-resolution HDR image, such as 24 bits per pixel as an illustrative example. Any suitable bits per pixel values may be implemented, with the examples described herein continuing to use the 24 and 12 bit per pixel images. Thus, the acquired image 302 in this scenario may comprise for instance a “raw” 12 bit per pixel HDR image. The sensor information may include lookup table (LUT) data used to linearize the raw 12 bit per pixel HDR image back to a “raw” 24 bit per pixel image, for example, in accordance with any suitable HDR companding techniques, including known techniques. This LUT may be referred to herein as a linearization LUT and function to map the 12 bit values per pixel to 24 bit pixel values as part of an expansion process. As a result, the linearization LUT may identify a 24 bit value for each 12 bit pixel value in the acquired image 302.

Again, the sensor information may include any suitable information regarding the image sensor that generated the acquired image 302. This information may, for instance, be used to construct a pixel model that maps the 12 bit per pixel values to corresponding light levels, which may be represented as digital light level values. To do so, the block as shown in FIG. 4 identified with the noise model 402 may additionally include an intermediate light level LUT that maps values obtained via the use of this pixel model to each 12 bit pixel value in the acquired image 302. The pixel model used for the entries in the intermediate light level LUT may utilize any suitable sensor information, such as sensitivity (e.g. expressed in electrons per lux-second) and the K factor, which is a numerical value used in image processing algorithms to adjust the relative contribution of different exposure levels when combining multiple images to create a final HDR image. The sensor information may also include, for instance, exposure time and gain.

Using this sensor information, the pixel model may provide the data entries in the intermediate light level LUT via the following relationship:

$$Pixel model \text{:} Conv\_input \_Light \_codes = Sensitivity ( e / lx * s ) * K\_factor ( codes / e ) * exposure time * gain .$$

The results of the intermediate light level LUT thus function to map a corresponding light level to each pixel in the acquired image 302. The values in the linearization LUT may then be divided by the resulting values in the light level LUT to yield a light level LUT in the resolution of the acquired image 302 (e.g. 12 bits).

Once the values of the light level LUT are obtained in this manner, a light level may be obtained for each pixel in the acquired image based upon each pixel's value in the lower resolution (e.g. 12 bit) acquired image 302. Next, further sensor information such as sensitivity, noise sources, sensor temperature, HDR composition, etc., may be leveraged to generate an SNR model that provides a noise per pixel in the higher resolution image (e.g. 24 bits) from which the acquired image 302 was companded. The SNR model may be expressed, for instance, via the following relationship:

$$SNR model \text{:} f ( light level ) = signal to noise , light level = noise per pixel ( 24 b ) .$$

In other words, assuming 24 bit and 12 bit images as noted above, the SNR model may function to map each pixel's light level in the lower resolution acquires image 302 to a corresponding noise per pixel level in the higher resolution (e.g. 24 bit image). The SNR model may thus be used to generate a noise per pixel LUT that contains entries that map each pixel in the lower resolution (e.g. 12 bit) light level value to a corresponding noise level per pixel in the higher (e.g. 24 bit) image.

Next, the entries in the linearization LUT and the light level LUT may be utilized to convert each noise level per pixel in the higher resolution (e.g. 24 bit) image to a corresponding noise level per pixel in the lower resolution (e.g. 12 bit) image. This may additionally utilize, as part of the sensor information, data regarding the compression curve used for the companding process that provided the acquired image 302.

With this information available, the noise model 402 may then be generated to map noise per pixel values of the lower resolution acquired image 302 (e.g. a 12 bit image) to the noise per pixel values in the higher resolution image (e.g. 24 bit) from which the acquired image 302 was generated by way of the companding process. In other words, the noise model 402 may function to provide the estimated noise per pixel 404 using information regarding the HDR companding process that was used to provide the acquired image 302.

As an illustrative example, if a pixel value of the acquired image 302 is 3840, the noise model 402 generated as discussed in this Section may output a noise value of 16, which requires four bits to encode. Thus, the residual image compression block 406 may utilize this information to drop the last 4 bits of the residual image 306.

Thus, the block as shown in FIG. 4 identified with the noise model 402 may additionally include any of the LUTs as described herein, executable instructions that, when executed via any suitable processing components (e.g. the one or more processors 102, one or more of the processors 214A, 214B, 216, 218, etc.), result in obtaining such values, and/or may otherwise receive any of the data values associated with such LUTs from any suitable data source.

Furthermore, the construction of the noise model 402 using information from the HDR companding process may be used independently or in conjunction with any of the other noise model generation techniques as discussed herein. As an illustrative example, the noise model 402 as shown in FIG. 4 may include several noise models, each being generated in accordance with any of the techniques as described herein. The estimated noise per pixel 404 as shown in FIG. 4 may include, per pixel, the highest noise level that is output from among such a set of noise models. In this way, the residual image compression 406 may utilize the highest noise value to ensure an optimal compression of the compressed residual image 308.

Moreover, it is noted that CV algorithms and/or other suitable trained models typically require a “tone-mapping” or “histogram equalization” algorithm to reduce the HDR images from a higher value (e.g. 24 bpp) to a lower value (e.g. 8 bpp). These algorithms/models may be adaptable to the regional intensity of a scene, and may thus “hide” a certain amount of quantization noise in the scene. Thus, the embodiments as discussed herein, which may function to remove lower bits identified as noise, may enable such CV algorithms to be even further resilient to quantization noise.

Still further, embodiments include adjusting any suitable parameters of the noise model 402 during operation and/or after any suitable period of operation as part of a particular application (e.g. when deployed in the vehicle 100 and used in accordance with a CV algorithm). Furthermore, such adjustments may be made for any suitable purpose, such as testing and/or development with respect to new sensors and/or new sensor configurations, which may include the use of the noise model 401 as part of a simulation environment. For instance, the noise model 401 may be configured to simulate the effects of new sensors on compression (or other suitable operational parameters). To provide an illustrative example, this may be particularly useful to determine that reducing the pixel noise in one particular range of a sensor's operation has no impact (or a negligible impact) on the resulting CV performance, and instead reduces the amount of data that may be compressed. Thus, by adapting the noise model 401 for use as a simulator in this manner, additional CV configurations, sensors, compression schemes, etc., may be tested by analyzing the output of the noise model 401 to provide helpful insights regarding future development of the system in which the noise model 401 is implemented.

### VI. A Process Flow

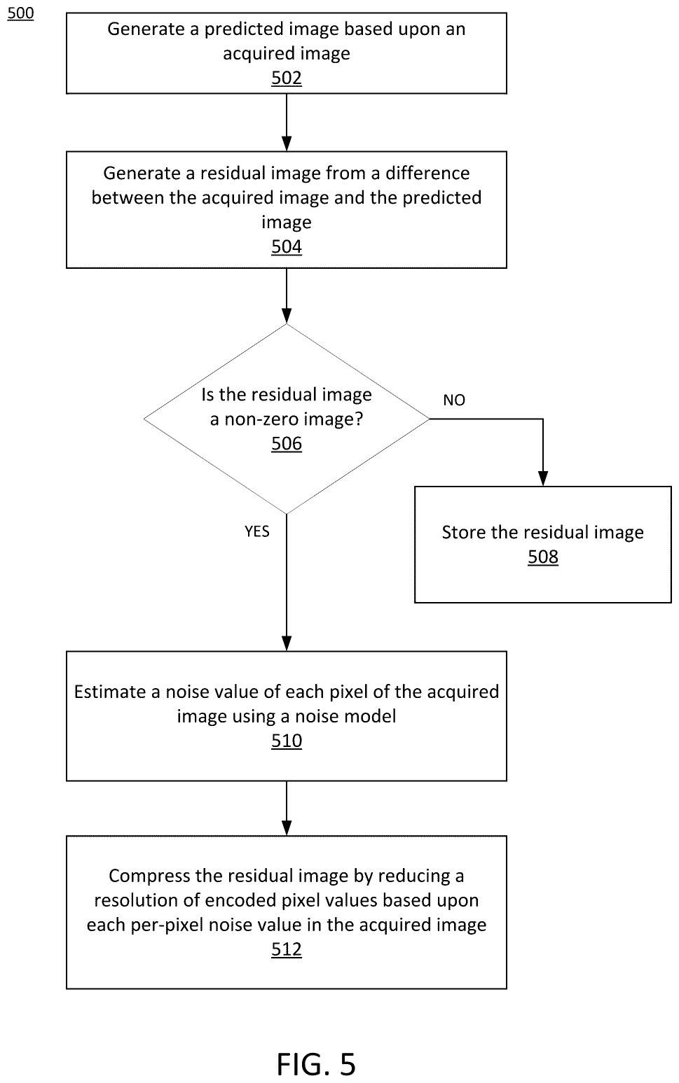

FIG. 5 illustrates an example of a process flow, in accordance with one or more aspects of the disclosure. The process flow 500 may include alternate or additional steps that are not shown in FIG. 5 for purposes of brevity, and may be performed in a different order than the steps shown in FIG. 5.

With reference to FIG. 5, the process flow 500 may be a computer-implemented method executed by and/or otherwise associated with one or more processors (processing circuitry) and/or storage devices. The functionality associated with the process flow 500 as discussed herein may be executed, for instance, via a suitable computing device and/or processing circuitry identified with the vehicle 100 and/or the safety system 200. This may include, for example, the one or more processors 102, one or more of the processors 214A, 214B, 216, 218, etc., executing instructions stored in a suitable memory (e.g. the one or more memories 202). In other aspects, the functionality associated with the process flow 500 as discussed herein may be executed, for instance, via processing circuitry identified with any suitable type of computing device that may be identified with the vehicle 100 (e.g. a chip, an aftermarket product, etc.) or otherwise communicates with one or more components of the vehicle 100.

The functionally as discussed with respect to the process flow 500 may additionally or alternatively be executed via one or more other computing devices separate from the vehicle 100, such as the remote computing system 150 as discussed herein. It is also noted that any portions of the process flow 500 may be executed by different components within the vehicle 100 and/or another computing device, and may also be executed via different types of computing devices. For instance, images may be acquired via the vehicle 100, but the image prediction and residual compression techniques as described herein may be executed via the vehicle 100 or a different computing device, e.g. the remote computing system 150.

The process flow 500 may begin with the generation (block 502) of a predicted image based upon an acquired image. The acquired image may, for example, comprise the acquired image 302 as discussed herein. The predicted image may, for example, comprise the predicted image 304 as discussed herein.

The process flow 500 may include generating (block 504) a residual image from a difference between the acquired image and the predicted image. The residual image may, for example comprise the residual image 306 as discussed herein.

The process flow 500 may include determining (block 506) whether the residual image is a non-zero image. In other words, if the residual image comprises all zeroes, then the predicted image matches the acquired image with zero error, and the residual image cannot be further compressed in this scenario. Thus, the residual image is then stored (block 508).

However, if the residual image comprises a non-zero image, then the residual image is compressible. In this case, the process flow 500 includes estimating (block 510) a noise value of each pixel in the acquired image by inputting the acquired image into a generated noise model The noise model may be identified, for instance, with the noise model 402 as discussed herein, and may be generated using intrinsic information of the sensor used to generate the acquired image and/or in accordance with nay suitable training techniques, as noted above.

The process flow 500 may comprise compressing (block 512) the residual image to generate a compressed residual image. This compressed residual image may comprise, for instance, the compressed residual image 308 as discussed herein. This may include, for instance, reducing a resolution of the residual image by zeroing out a number of LSBs used to encode each of the pixel values of the residual image. Again, the reduction in resolution (i.e. the number of LSBs zeroed out in this manner) may be based upon a bit value per pixel that corresponds to the number to bits needed to encode the estimated noise value per each corresponding pixel of the acquired image, as discussed above.

### Examples

The following examples pertain to further aspects.

An example (e.g. example 1) is directed to a method, comprising: generating, via an image predictor, a predicted image based upon an acquired image; generating a residual image that represents a difference between the acquired image and the predicted image; estimating, for each pixel in the acquired image using a noise model, a per-pixel noise value, wherein the noise model is generated based upon sensor information associated with a sensor used to capture the acquired image; and compressing the residual image by reducing a resolution of encoded pixel values of the residual image based upon each per-pixel noise value in the acquired image.

Another example (e.g. example 2) relates to a previously-described example (e.g. example 1), wherein the compressing the residual image comprises: reducing, for each pixel in the residual image, a resolution of a respective encoded pixel value by converting a number of bits that are used to represent the respective encoded pixel value to zero.

Another example (e.g. example 3) relates to a previously-described example (e.g. any combination of one or more of examples 1-2), wherein the compressing the residual image comprises: computing a respective bit value needed to encode each per-pixel noise value, wherein the number of bits that are converted to zero per each respective encoded pixel value of the residual image are equal to the respective bit value needed to encode each per-pixel noise value from the acquired image.

Another example (e.g. example 4) relates to a previously-described example (e.g. any combination of one or more of examples 1-3), further comprising: generating a reconstructed image of the acquired image using the compressed residual image and the predicted image, wherein the reconstructed image is perceptually lossless due to noise induced by the compression of the residual image being no greater than noise induced by the sensor.

Another example (e.g. example 5) relates to a previously-described example (e.g. any combination of one or more of examples 1-4), wherein the image predictor comprises an auto-encoder, a differential pulse-code modulation (DPCM) predictor, or a LOCO (LOW Complexity LOssless Compression) predictor.

Another example (e.g. example 6) relates to a previously-described example (e.g. any combination of one or more of examples 1-5), wherein the sensor comprises a camera that is part of a vehicle, and wherein the acquired image comprises an image of a driving environment that is captured via the camera during operation of the vehicle.

Another example (e.g. example 7) relates to a previously-described example (e.g. any combination of one or more of examples 1-6), wherein the sensor comprises a camera that is part of a vehicle, and further comprising: generating a reconstructed image of the acquired image using the compressed residual image and the predicted image; and adding the reconstructed image to a training data set that is used to train a machine learning model to perform vehicle-based functions.

Another example (e.g. example 8) relates to a previously-described example (e.g. any combination of one or more of examples 1-7), wherein the acquired image comprises a high dynamic range (HDR) image.

An example (e.g. example 9) is directed to a navigation system for use in navigating a host vehicle, comprising: at least one processor comprising circuitry and a memory, wherein the memory includes instructions that when executed by the circuitry cause the at least one processor to: generate, via an image predictor, a predicted image based upon an acquired image; generate a residual image that represents a difference between the acquired image and the predicted image; estimate, for each pixel in the acquired image using a noise model, a respective per-pixel noise value, wherein the noise model is generated based upon sensor information associated with a sensor used to capture the acquired image; and compress the residual image by reducing a resolution of encoded pixel values of the residual image based upon each per-pixel noise value in the acquired image.

Another example (e.g. example 10) relates to a previously-described example (e.g. example 9), wherein the compressing the residual image comprises: reducing, for each pixel in the residual image, a resolution of a respective encoded pixel value by converting a number of bits that are used to represent the respective encoded pixel value to zero.

Another example (e.g. example 11) relates to a previously-described example (e.g. any combination of one or more of examples 8-10), wherein the compressing the residual image comprises: computing a respective bit value needed to encode each per-pixel noise value, wherein the number of bits that are converted to zero per each respective encoded pixel value of the residual image are equal to the respective bit value needed to encode each per-pixel noise value from the acquired image.

Another example (e.g. example 12) relates to a previously-described example (e.g. any combination of one or more of examples 8-11), wherein the circuitry of the at least one processor is further configured to execute the instructions stored in the memory to: generate a reconstructed image of the acquired image using the compressed residual image and the predicted image, wherein the reconstructed image is perceptually lossless due to noise induced by the compression of the residual image being no greater than noise induced by the sensor.

Another example (e.g. example 13) relates to a previously-described example (e.g. any combination of one or more of examples 8-12), wherein the image predictor comprises an auto-encoder, a differential pulse-code modulation (DPCM) predictor, or a LOCO (LOw Complexity LOssless Compression) predictor.

Another example (e.g. example 14) relates to a previously-described example (e.g. any combination of one or more of examples 8-13), wherein the sensor comprises a camera that is part of the vehicle, and wherein the acquired image comprises an image of a driving environment that is captured via the camera during operation of the vehicle.

Another example (e.g. example 15) relates to a previously-described example (e.g. any combination of one or more of examples 8-14), wherein the sensor comprises a camera that is part of the vehicle, and wherein the circuitry of the at least one processor is further configured to execute the instructions stored in the memory to: generate a reconstructed image of the acquired image using the compressed residual image and the predicted image; and add the reconstructed image to a training data set that is used to train a machine learning model to perform vehicle-based functions.

An Example (e.g. example 16) is directed to a non-transitory computer-readable medium having instructions stored thereon that, when executed by processing circuitry associated with a vehicle, cause the vehicle to: generate, via an image predictor, a predicted image based upon an acquired image; generate a residual image that represents a difference between the acquired image and the predicted image; estimate, for each pixel in the acquired image using a noise model, a per-pixel noise value, wherein the noise model is trained based upon sensor information associated with a sensor used to capture the acquired image; and compress the residual image by reducing a resolution of encoded pixel values of the residual image based upon each per-pixel noise value in the acquired image.

Another example (e.g. example 17) relates to a previously-described example (e.g. example 16), wherein the compressing the residual image comprises: reducing, for each pixel in the residual image, a resolution of a respective encoded pixel value by converting a number of bits that are used to represent the respective encoded pixel value to zero.

Another example (e.g. example 18) relates to a previously-described example (e.g. any combination of one or more of examples 16-17), wherein the compressing the residual image comprises: computing a respective bit value needed to encode each per-pixel noise value, and wherein the number of bits that are converted to zero per each respective encoded pixel value of the residual image are equal to the respective bit value needed to encode each per-pixel noise value from the acquired image.

Another example (e.g. example 19) relates to a previously-described example (e.g. any combination of one or more of examples 16-18), wherein the processing circuitry is further configured to execute the instructions to cause the vehicle to: generate a reconstructed image of the acquired image using the compressed residual image and the predicted image, wherein the reconstructed image is perceptually lossless due to noise induced by the compression of the residual image being no greater than noise induced by the sensor.

Another example (e.g. example 20) relates to a previously-described example (e.g. any combination of one or more of examples 16-19), wherein the image predictor comprises an auto-encoder, a differential pulse-code modulation (DPCM) predictor, or a LOCO (LOw Complexity LOssless Compression) predictor.

Another example (e.g. example 21) relates to a previously-described example (e.g. any combination of one or more of examples 16-20), wherein the sensor comprises a camera that is part of the vehicle, and wherein the acquired image comprises an image of a driving environment that is captured via the camera during operation of the vehicle.

Another example (e.g. example 22) relates to a previously-described example (e.g. any combination of one or more of examples 16-21), wherein the sensor comprises a camera that is part of the vehicle, and wherein the processing circuitry is further configured to execute the instructions to cause the vehicle to: generate a reconstructed image of the acquired image using the compressed residual image and the predicted image; and add the reconstructed image to a training data set that is used to train a machine learning model to perform vehicle-based functions.

A method as shown and described.

An apparatus as shown and described.

### Conclusion

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

1-22. (canceled)

23. A method, comprising:
generating, via an image predictor, a predicted image based upon an acquired image;
generating a residual image;
estimating, for each pixel in the acquired image using a noise model, a per-pixel noise value,
wherein the noise model is generated based upon sensor information associated with a sensor used to capture the acquired image; and
compressing the residual image by reducing a resolution of encoded pixel values of the residual image based upon each per-pixel noise value in the acquired image.

24. The method of claim 23, wherein the residual image represents a difference between the acquired image and the predicted image

25. The method of claim 23, wherein the compressing the residual image comprises:
reducing, for each pixel in the residual image, a resolution of a respective encoded pixel value by converting a number of bits that are used to represent the respective encoded pixel value to zero.

26. The method of claim 25, wherein the compressing the residual image comprises:
computing a respective bit value needed to encode each per-pixel noise value,
wherein the number of bits that are converted to zero per each respective encoded pixel value of the residual image are equal to the respective bit value needed to encode each per-pixel noise value from the acquired image.

27. The method of claim 23, further comprising:
generating a reconstructed image of the acquired image using the compressed residual image and the predicted image,
wherein the reconstructed image is perceptually lossless due to noise induced by the compression of the residual image being no greater than noise induced by the sensor.

28. The method of claim 27, wherein the reconstructed image being perceptually lossless enables vehicle-based functions to be performed via an autonomous vehicle (AV) and/or an advanced driver-assistance system (ADAS) in the same manner using the reconstructed image and the acquired image.

29. The method of claim 23, wherein the image predictor comprises an auto-encoder, a differential pulse-code modulation (DPCM) predictor, or a LOCO (LOW Complexity LOssless Compression) predictor.

30. The method of claim 23, wherein the sensor comprises a camera that is part of a vehicle, and
wherein the acquired image comprises an image of a driving environment that is captured via the camera during operation of the vehicle.

31. The method of claim 23, wherein the sensor comprises a camera that is part of a vehicle, and further comprising:
generating a reconstructed image of the acquired image using the compressed residual image and the predicted image; and
adding the reconstructed image to a training data set that is used to train a machine learning model to perform vehicle-based functions.

32. The method of claim 23, wherein the acquired image comprises a high dynamic range (HDR) image.

33. A navigation system for use in navigating a host vehicle, comprising:
at least one processor comprising circuitry and a memory, wherein the memory includes instructions that when executed by the circuitry cause the at least one processor to:
generate, via an image predictor, a predicted image based upon an acquired image;
generate a residual image;
estimate, for each pixel in the acquired image using a noise model, a respective per-pixel noise value,
wherein the noise model is generated based upon sensor information associated with a sensor used to capture the acquired image; and
compress the residual image by reducing a resolution of encoded pixel values of the residual image based upon each per-pixel noise value in the acquired image.

34. The navigation system of claim 33, wherein the residual image represents a difference between the acquired image and the predicted image.

35. The navigation system of claim 33, wherein the compressing the residual image comprises:
reducing, for each pixel in the residual image, a resolution of a respective encoded pixel value by converting a number of bits that are used to represent the respective encoded pixel value to zero.

36. The navigation system of claim 35, wherein the compressing the residual image comprises:
computing a respective bit value needed to encode each per-pixel noise value,
wherein the number of bits that are converted to zero per each respective encoded pixel value of the residual image are equal to the respective bit value needed to encode each per-pixel noise value from the acquired image.

37. The navigation system of claim 33, wherein the circuitry of the at least one processor is further configured to execute the instructions stored in the memory to:
generate a reconstructed image of the acquired image using the compressed residual image and the predicted image,
wherein the reconstructed image is perceptually lossless due to noise induced by the compression of the residual image being no greater than noise induced by the sensor.

38. The navigation system of claim 37, wherein the reconstructed image being perceptually lossless enables vehicle-based functions to be performed via an autonomous vehicle (AV) and/or an advanced driver-assistance system (ADAS) of the host vehicle in the same manner using the reconstructed image and the acquired image.

39. The navigation system of claim 33, wherein the image predictor comprises an auto-encoder, a differential pulse-code modulation (DPCM) predictor, or a LOCO (LOW Complexity LOssless Compression) predictor.

40. The navigation system of claim 33, wherein the sensor comprises a camera that is part of the vehicle, and
wherein the acquired image comprises an image of a driving environment that is captured via the camera during operation of the vehicle.

41. The navigation system of claim 33, wherein the sensor comprises a camera that is part of the vehicle, and
wherein the circuitry of the at least one processor is further configured to execute the instructions stored in the memory to:
generate a reconstructed image of the acquired image using the compressed residual image and the predicted image; and
add the reconstructed image to a training data set that is used to train a machine learning model to perform vehicle-based functions.

42. A non-transitory computer-readable medium having instructions stored thereon that, when executed by processing circuitry associated with a vehicle, cause the vehicle to:
generate, via an image predictor, a predicted image based upon an acquired image;
generate a residual image;
estimate, for each pixel in the acquired image using a noise model, a per-pixel noise value,
wherein the noise model is trained based upon sensor information associated with a sensor used to capture the acquired image; and
compress the residual image by reducing a resolution of encoded pixel values of the residual image based upon each per-pixel noise value in the acquired image.

43. The non-transitory computer-readable medium of claim 42, wherein the residual image represents a difference between the acquired image and the predicted image.

44. The non-transitory computer-readable medium of claim 42, wherein the compressing the residual image comprises:
reducing, for each pixel in the residual image, a resolution of a respective encoded pixel value by converting a number of bits that are used to represent the respective encoded pixel value to zero.

45. The non-transitory computer-readable medium of claim 44, wherein the compressing the residual image comprises:
computing a respective bit value needed to encode each per-pixel noise value, and
wherein the number of bits that are converted to zero per each respective encoded pixel value of the residual image are equal to the respective bit value needed to encode each per-pixel noise value from the acquired image.

46. The non-transitory computer-readable medium of claim 42, wherein the processing circuitry is further configured to execute the instructions to cause the vehicle to:
generate a reconstructed image of the acquired image using the compressed residual image and the predicted image,
wherein the reconstructed image is perceptually lossless due to noise induced by the compression of the residual image being no greater than noise induced by the sensor.

47. The non-transitory computer-readable medium of claim 46, wherein the reconstructed image being perceptually lossless enables vehicle-based functions to be performed via an autonomous vehicle (AV) and/or an advanced driver-assistance system (ADAS) of the vehicle in the same manner using the reconstructed image and the acquired image.

48. The non-transitory computer-readable medium of claim 42, wherein the image predictor comprises an auto-encoder, a differential pulse-code modulation (DPCM) predictor, or a LOCO (LOW Complexity LOssless Compression) predictor.

49. The non-transitory computer-readable medium of claim 42, wherein the sensor comprises a camera that is part of the vehicle, and
wherein the acquired image comprises an image of a driving environment that is captured via the camera during operation of the vehicle.

50. The non-transitory computer-readable medium of claim 42, wherein the sensor comprises a camera that is part of the vehicle, and
wherein the processing circuitry is further configured to execute the instructions to cause the vehicle to:
generate a reconstructed image of the acquired image using the compressed residual image and the predicted image; and
add the reconstructed image to a training data set that is used to train a machine learning model to perform vehicle-based functions.
